(19) United States
(12) Patent Application Publication
(10) Pub. No.: US 2006/0006671 A1
(43) Pub. Date: Jan. 12, 2006

(54) Automobile vehicle lock

(76) Inventors: Jean-Pierre Noel, Raon L'Etape (FR); Jean-Marc Belmond, St. Jean Le Blanc (FR); Frederic Burkat, Bouzy La Foret (FR); Eric Colin, Saint Die (FR); Veronique Mejean, Saint Die (FR); Vincent Poirot, St. Loup Sur Semouse (FR); Richard Grandjean, Sainte Marguerite (FR)

Correspondence Address: CARLSON, GASKEY & OLDS, P.C., 400 WEST MAPLE ROAD, SUITE 350, BIRMINGHAM, MI, 48009, US

(21) Appl. No.: 11/148,979

(22) Filed: Jun. 9, 2005

(30) Foreign Application Priority Data
Jun. 18, 2004 (FR) 04 06 640

(51) Int. Cl. E05C 3/06

(52) U.S. Cl. 292/216

(57) ABSTRACT

An electro-mechanical latch mechanism of a lock includes a latch claw that can move to close and release the latch mechanism and a pawl adapted to keep the latch claw in a closed position. Cooperating means have a point of action that can be operated on by a release lever, as well as a point of action that can be operated on by an electric motor. The pawl is linked to the latch claw by a unidirectional linkage that can be coupled-in and coupled-out electrically. Starting out from this core design, a whole range of locks can be built up by a suitable choice of release levers and electric motors and by suitable programming of the electric motor for coupling in and coupling out the unidirectional linkage between the pawl and the latch claw.

### REFERENCE TO RELATED APPLICATIONS

This application claims priority to French Patent Application 04 06 640 filed on Jun. 18, 2004.

### BACKGROUND OF THE INVENTION

The present invention relates generally to automobile vehicle locks.

Locks are used to keep an automobile vehicle door or the like in a closed position. They also allow the door or the like to be opened by operating an inside or external manipulator linked to a latch mechanism and are able to be operated by a user. Typically, such locks are mounted on the vehicle door. They include a latch claw designed to engage with or be disengaged from a pin or striker bar mounted on the vehicle. Releasing the latch mechanism involves disengaging the latch claw from the striker bar, allowing the door or the like to be opened. Inversely, closing the latch mechanism involves keeping the striker bar engaged by the latch claw and preventing the door or the like from being opened. The latch claw is urged into its closing position by the striker bar when the door is being closed, and a pawl prevents the latch claw from returning to the release position, keeping the latch mechanism in the closed position if the latch mechanism is not subject to external action.

Herein, we shall call the part of the latch mechanism connecting the external release control or the inside release control the external release lever or the inside release lever, respectively. Locking of the latch mechanism, as employed herein, involves preventing the latch mechanism from being opened by using the external release control. Unlocking is the reverse operation, allowing the latch mechanism to again be released when the external release control is manipulated. In the case of an automobile vehicle door, these operations are conventionally performed using a fascia pull or an electromechanical actuator. In the case of a hatchback door or trunk, an interlocking device is also used for locking or unlocking purposes.

Herein, “security locking” involves preventing the latch mechanism from being released by operating the inside release control, with the door or the like locked. Security locking notably prevents a vehicle door from being opened using the inside release control after the window glass has been broken. “Security locking release” is the reverse operation, including again allowing the latch mechanism to be opened by operating the inside release control. In the case of an automobile vehicle door, these operations are conventionally performed using a specific electromechanical actuator. Examples can be found in the model year 2000 Peugeot 406 or the model year 2000 Audi A4 which use locks of this type. A child-proof feature prevents the latch mechanism from being opened from the inside regardless of whether it is locked or not. This feature prevents a vehicle door from being accidentally opened from inside, notably by children. It is frequently provided on the rear doors of vehicles. For a vehicle rear door, these operations are conventionally performed using a mechanical control or electromechanical actuator. The model year 2000 Volkswagen Golf or the model year 2000 Renault Laguna II adopt such a solution.

An override feature allows the latch mechanism to be opened and locking to be released simultaneously or the latch mechanism to be unlocked by operating the inside release control with the child-proof set. This allows a door latch mechanism to be released in the event of an accident, allowing a passenger at the rear of the vehicle with the child-proof feature set to unlock the latch mechanism, allowing the door to be opened from the outside.

A double override feature allows the latch mechanism to be simultaneously unlocked and released by operating the release control twice.

Numerous designs of mechanical and electromechanical latch mechanisms exist that implement one or several of these features. Herein, a mechanical latch mechanism is one in which the release mechanism is actuated by a mechanical linkage such as by, for example, pulling on a cable. An electrical latch mechanism herein is one in which the release mechanism is actuated by a gear mechanism driven by an electric motor.

Reference can for example be made to European patent application EP-A-1,335,087, which discusses several designs of prior art locks as well as an electric latch mechanism, making it possible to provide the above features under degraded electrical conditions.

Mechanically or electrically released latch mechanisms can vary considerably from one model of vehicle to another. Depending on the vehicle ranges, different latch mechanisms offering different functions will be fitted to the doors and other openable members of the vehicle. In particular, the driver's door frequently has functions different from those of, for example, the rear doors. It is consequently necessary to manage, for a given vehicle, several different latch mechanisms having different functionalities.

Now, manufacturers attempt to reduce the number of part references to simplify part ordering and production, together with storage and assembly of the parts onto vehicles. In the case of a latch mechanism, current practice requires making provisions for a model of latch mechanism, i.e., a specific reference, per vehicle range or even for the various openable members of a given vehicle range.

There is consequently a need for a standardized “core” latch mechanism, enabling any type of lock able to partially or fully implement the various functions discussed above to be built: locking, release of locking, security locking, release of security locking, child safety function actuation/release, override.

### SUMMARY OF THE INVENTION

The invention provides an electro-mechanical latch mechanism including a latch claw movable between a released position in which the latch mechanism is released and a closed position in which the latch mechanism is closed, a pawl adapted to maintain the latch claw in the closed position, cooperating means having a point of action adapted to be operated on by a latch mechanism release lever and a unidirectional linkage that can be coupled-in and coupled-out electrically between the cooperating means and the pawl.

In one embodiment, the cooperating means further include a point of action adapted to be operated on by a motor. In another embodiment, the latch mechanism further includes a standby lever operated by an electric motor between an active position for coupling in the cooperating means and an inactive position for coupling out the cooperating means. The cooperating means can include a finger, and the standby lever includes a cam adapted to come into abutment with the finger in the active position. In one embodiment, the standby lever carries a spring adapted to permit an intermediate position of the standby lever.

In another embodiment, the cooperating means includes a first window adapted to receive a lug integral with the pawl, and the shape of the first window is adapted to provide a unidirectional linkage between the cooperating means and the pawl when the linkage is in a coupled-in state. The cooperating means can have a second window adapted to receive a point of action by the lever. In one embodiment, the cooperating means includes a finger adapted to receive a point of action by the motor.

The present invention also provides a module including the above-described latch mechanism, an electrical release motor for the latch mechanism adapted to act on the cooperating means and a mechanical release lever adapted to act on the cooperating means. The unidirectional linkage between the cooperating means and the pawl is coupled-in by the release motor.

The a standby lever is adapted to be operated by a standby motor. The unidirectional linkage between the cooperating means and the pawl is coupled-in by the lever in the event of an electrical failure of the release motor.

A module including the above-described latch mechanism, a mechanical release lever adapted to operate on the cooperating means and a standby lever adapted to be operated on by a motor is also provided. The unidirectional linkage between the cooperating means and the pawl is coupled-in and coupled-out by the operation of the standby lever. The invention further provides a vehicle having an openable member fitted with the above latch mechanism or module(s).

Further characteristics and advantages of the latch mechanism will become more clear from the description which follows provided by way of example, with reference to the attached drawings.

### BRIEF DESCRIPTION OF THE DRAWINGS

FIG. 1 is a diagrammatic view of a latch mechanism according to one embodiment of the invention in a closed position with electro-mechanical release;

FIG. 2 is a view of the latch mechanism in FIG. 1, showing how the various parts of the latch mechanism move during electro-mechanical opening of the latch mechanism in normal operation;

FIG. 3 is a view of the latch mechanism in FIG. 1, showing how the various parts of the latch mechanism move during electro-mechanical opening of the latch mechanism in normal operation;

FIG. 4 is a view of the latch mechanism in FIG. 1, showing how the various parts of the latch mechanism move during electro-mechanical opening of the latch mechanism in normal operation;

FIG. 5 shows the latch mechanism in FIG. 1 in a closed position and with purely mechanical emergency opening;

FIG. 6 is a diagrammatic view of a latch mechanism according to another embodiment in a closed position with purely mechanical opening;

FIG. 7 shows an example of modular locks able to be obtained starting from a latch mechanism according to the invention;

FIG. 8 shows an example of modular locks able to be obtained starting from the latch mechanism according to the invention;

FIG. 9 shows an example of modular locks able to be obtained starting from the latch mechanism according to the invention;

FIG. 10 shows an example of modular locks able to be obtained starting from the latch mechanism according to the invention; and

FIG. 11 shows an example of modular locks able to be obtained starting from the latch mechanism according to the invention.

### DETAILED DESCRIPTION OF THE PREFERRED EMBODIMENT

The invention provides a modular lock. One identical core latch mechanism makes it possible, depending on the mode of assembly and parts that are added, to constitute locks having different functionalities. In particular, a given mechanical structure of a lock can, depending on the electronic programming of an electric motor associated therewith and on the parts that are added, provide the above-mentioned various functionalities.

The electro-mechanical latch mechanism includes a latch claw movable between a first position allowing the latch mechanism to be released and another position in which the latch mechanism is locked and a pawl adapted to keep the latch claw in a closed position. The latch mechanism also includes cooperating means having an operating point of action adapted to be operated on by a release lever. The cooperating means of the latch mechanism according to the invention are consequently provided structurally with a point of mechanical engagement allowing the cooperating means to change position when acted on by the release lever. The cooperating means can also have a point of action adapted to be acted on by an electric motor. In this case, the cooperating means have, structurally, a point of action adapted to be operated on by the mechanical action of the electric motor, allowing the cooperating means to change position. These two points of action for the release lever and the electric motor are not of necessity both activated, and this depends on the intended application of the lock.

A unidirectional linkage able to be coupled-in and coupled-out connects the cooperating means and the pawl. This one-way linkage ensures that the pawl is operated by the cooperating means, which receive the operating commands or actions, while the reverse, i.e., movement of the pawl, has no effect on the cooperating means. The linkage can be coupled-in electrically, allowing the pawl to be driven when the cooperating means changes position. The linkage can also be coupled-out electrically so that the pawl will not move when the cooperating means changes position.

Starting from this core latch mechanism, any other type of locks can be built by a suitable choice of release levers and electric motors with appropriate adaptation of the programming of the electric motor responsible for coupling-in and coupling-out the unidirectional linkage between the cooperating means and the pawl.

In the description below, we shall use the terms vertical, horizontal, left, right, top and bottom to refer to the position of the latch mechanism shown in the drawings. This position is for illustrative purposes and should not be understood as limiting the position of the latch mechanism in operation.

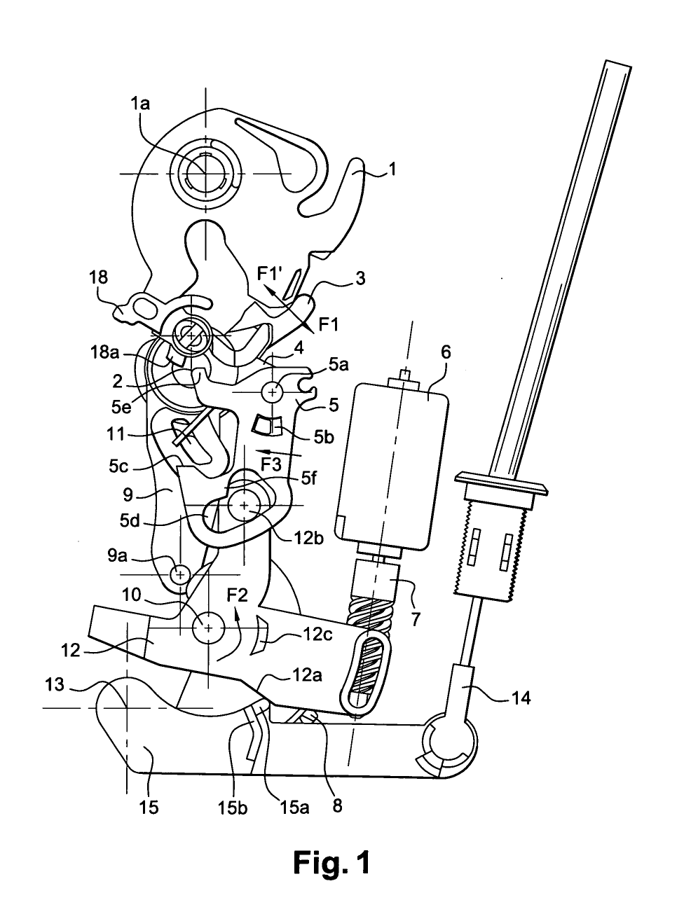

FIG. 1 is a diagrammatic view of a latch mechanism according to an embodiment of the invention in a closed position. The latch mechanism of FIG. 1 is an electro-mechanically released latch mechanism.

The latch mechanism in FIG. 1 has a core latch mechanism assembly including a latch claw 1, a pawl 3 and cooperating means 5. The cooperating means 5 are adapted to be operated by an electric motor 6 and/or a release lever 15. The connection between the cooperating means 5 and the pawl 3 is unidirectional, meaning that rotation of the cooperating means 5 can bring about rotation of the pawl 3, while inversely, rotation of the pawl 3 has no effect on the cooperating means 5.

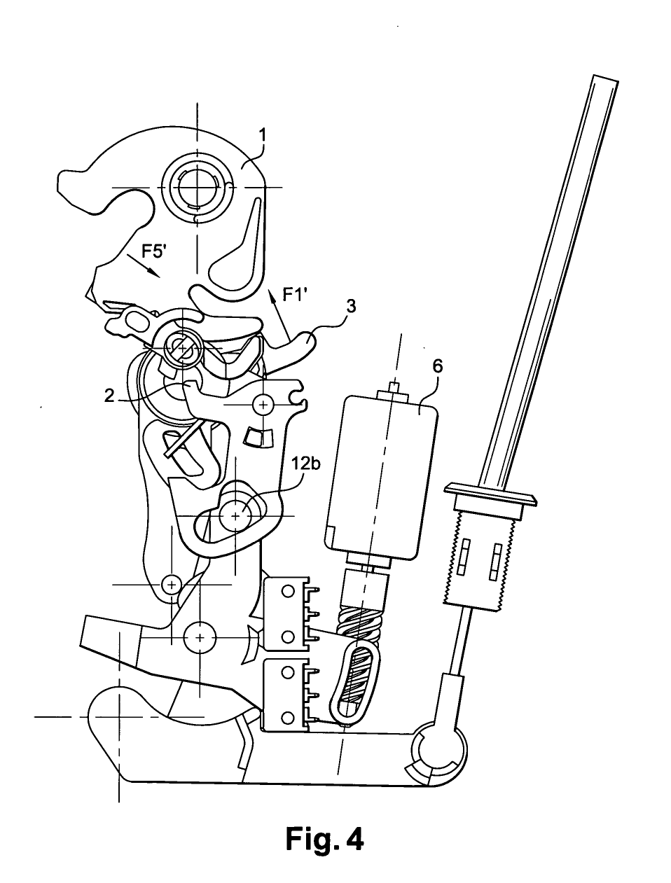

The drawings show the latch claw 1 rotatively mounted on an axis 1a. Rotation of the latch claw 1 about the axis 1a, in a clockwise sense, allows door release, as shown in FIG. 4. The latch claw 1 is urged by a spring in a clockwise direction towards its released position.

In the position of the latch claw 1 shown in FIG. 1, the pawl 3 prevents the door opening and keeps the latch claw 1 on a striker bar (not illustrated). The exact shape of the latch claw 1 and its movement are known per se and will not be described in more detail. They can additionally be modified without this having any bearing on the operation of the latch mechanism of the invention.

FIG. 1 also shows a pawl lifter 4. The pawl 3 and the pawl lifter 4 can rotate about an axis 2 and are integral with each other. The use of two parts is advantageous in view of assembly constraints. The pawl 3 and the pawl lifter 4 have drive lugs which cooperate together. Rotation of the pawl lifter 4 and the pawl 3 about the axis 2 in a clockwise direction has the effect of lowering the pawl 3 and releasing the latch claw 1 to allow the latch claw 1 to rotate clockwise and thereby release the latch mechanism.

FIG. 1 also shows an electrical release lever 9 including a drive key 11 mounted freely rotatable on the axis 2 of the pawl 3 and the pawl lifter 4. The electrical release lever 9 can be operated by the electric motor 6 that drives a toothed cam 8 via a worm 7. The cam 8 has a curved face adapted to urge an end 9a of the electrical release lever 9 to cause it to pivot about the axis 2.

FIG. 1 further shows the cooperating means 5 mounted in rotation about an axis 5a. The cooperating means 5 has a first window 5b in which a lug of the pawl lifter 4 is housed. The shape of the first window 5b is adapted to allow unidirectional linkage between the cooperating means 5 and the pawl 3. In particular, the first window 5b is larger than the lug of the pawl lifter 4. Rotation in the opposite direction of the pawl 3 will consequently have no effect on the cooperating means 5. Further, the size of the first window 5b allows an initial rotation of the cooperating means 5 about the axis 5a in a clockwise sense without driving the pawl lifter 4 and consequently the pawl 3.

The cooperating means 5 also includes a first finger 5c designed to cooperate with the key 11 of the electrical release lever 9. The first finger 5c thus constitutes a point of action of the cooperating means 5 adapted to be operated by the electric motor 6.

The release lever 15 manually or mechanically releases the door. The release lever 15 is rotatively mounted about an axis 13 and is connected by an external release cable or rod mechanism 14 to an external release control (not illustrated). The manual release lever 15 includes a protuberance 15a that abuts against a contact face 12a of a recall lever 12 able to rotate about an axis 10 common with the axis of the cam 8 with which the electric motor 6 is in geared engagement. The recall lever 12 is provided with a pin 12b housed in a second window 5d of the cooperating means 5. The second window 5d thus constitutes a point of action of the cooperating means 5 adapted to be operated on by a lever.

An inside manual release lever (not illustrated) is also adapted to act on the recall lever 12 in order to shift the pin 12b into the second window 5d of the cooperating means 5.

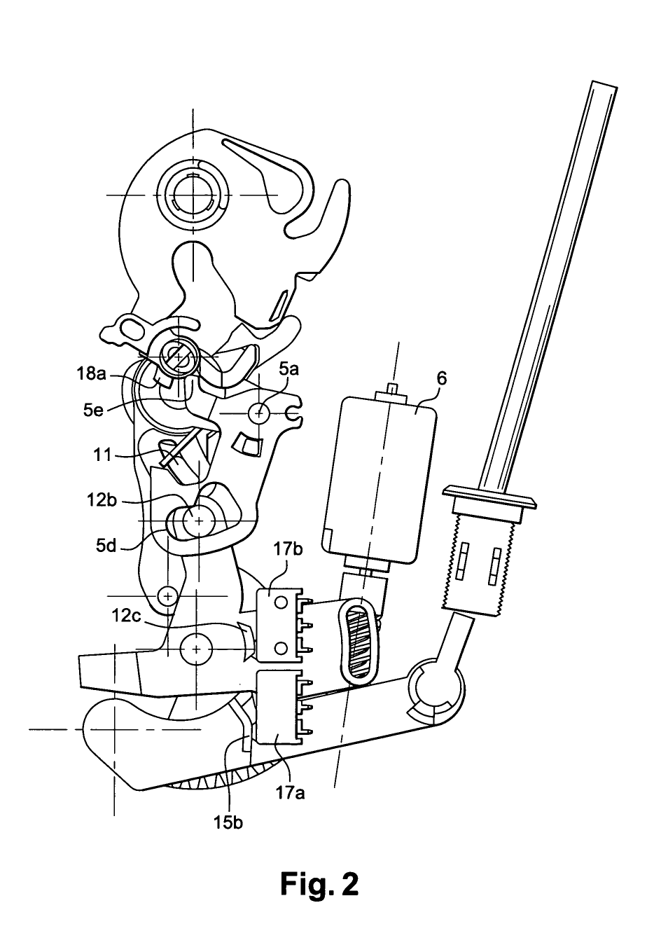

The external manual release lever 15 and the recall lever 12 each include electric contacts 12c and 15b, respectively designed to actuate switch contacts 17a and 17b, respectively, of the electric motor 6, as is shown in FIG. 2.

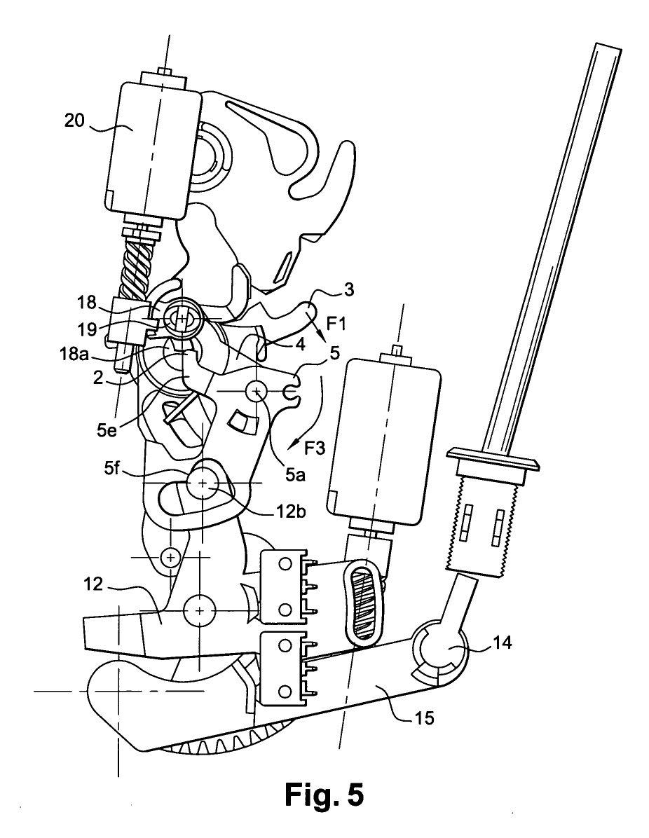

FIG. 1 shows a backup lever 18. The backup lever 18 is so-called because it can be operated by a backup standby motor 20, which can be seen in FIG. 5, to bring a cam 18a opposite a second finger 5e of the cooperating means 5. In this configuration, the cooperating means 5 lose their freedom to rotate about the axis 5a. Action on an inside or external release lever will bring the cooperating means 5 to rotate about the point of engagement between the second finger 5e of the cooperating means 5 and the cam 18a of the backup lever 18. This point of engagement is advantageously centered on the axis 2 of the pawl 3 and the pawl lifter 4.

The electrically released latch mechanism in FIG. 1 operates as follows. With the backup lever 18 in an inactive position in which the cam 18a of the backup lever 18 is not in engagement with the second finger Se of the cooperating means 5, the cooperating means are free to rotate about the axis 5a.

When an external mechanical release control or, respectively an inside release control, is operated, this rotates, via the external release cable or rod mechanism 14 (or, respectively, an inside release cable), the release lever 15 about an axis 13 (respectively, or the inside release lever about its axis), causing the recall lever 12 to swing about its axis of rotation 10 in the direction of arrow F2. The swinging movements of the external release lever 15 and the recall lever 12 cause the switch contacts 17a and 17b of the electric motor 6 to be brought into contact, as illustrated on FIG. 2.

The movement of recall lever 12 also drives the pin 12b, and the pin 12b shifts to abut against a face 5f inside the second window 5d, the effect of which is to cause the cooperating means 5 to swing about the axis of rotation 5a in the direction of arrow F3. The point of action by the lever of the cooperating means 5 is consequently activated. The swinging of the cooperating means 5 to the left and upwardly will allow the first finger 5c of the cooperating means 5 to engage with the key 11 of the electrical release lever 9, thereby activating the point of action by the electric motor 6 of the cooperating means 5.

In this position, the cooperating means 5 are not yet in a position to drive the pawl 3. In effect, during the initial movement of the cooperating means 5 under the action of the recall lever 12, the lug of the pawl lifter 4 simply slides with relative movement to the right inside the first window 5b of the cooperating means 5 without bringing about any rotational movement of the pawl 3. The unidirectional linkage between the cooperating means 5 and the pawl 3 is consequently coupled-out.

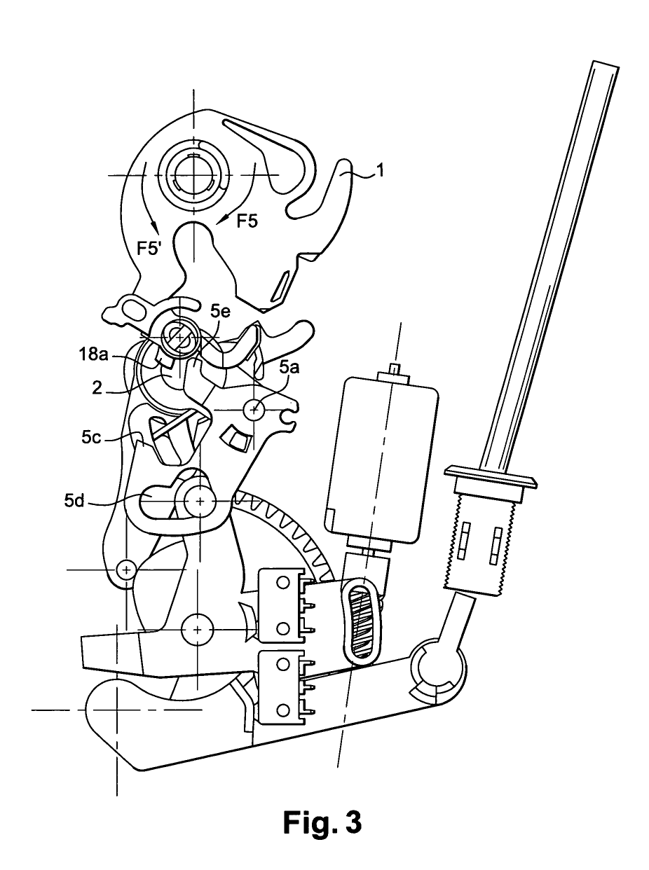

The electric motor 6 is now set running by closing the switch contacts 17a and 17b of the electric motor 6 by action from the mechanical release control. As can be seen in FIG. 3, operation of the electric motor 6 now causes the cam 8 to swing when driven by the worm 7. Swinging of the cam 8 now pushes the end 9a of the electrical release lever 9 upwardly to the left, causing the electrical release lever 9 to swing about the axis 2. As the cooperating means 5 have been rendered integral with the electrical release lever 9 by the key 11, the cooperating means 5 are driven in rotation about the axis 5a clockwise as a result of the first finger 5c thereof abutting on the key 11.

The cam 8, driven by the electric motor 6, is able to swing about the axis of rotation 10 between a rest position and a latch mechanism release position to shift the electric release lever 9 through an angle that is substantially the angle needed to release the latch mechanism.

As can be seen in FIG. 3, the rotation of the cooperating means 5 in the direction of arrow F3 also drives the pawl lifter 4 since its lug is in abutment at the right hand side inside the first window 5b of the cooperating means 5. The driving of the pawl lifter 4 by the cooperating means 5 will also drive the pawl 3, which is integral in rotation with the pawl 3. The unidirectional linkage between the cooperating means 5 and the pawl 3 is now coupled-in.

Rotation of the pawl 3 allows the latch claw 1 to be released from its locked positions. The latch claw 1 is now free to rotate in the direction of arrow F5 and release the latch mechanism to open the door. Movement in direction of arrow F5 occurs under the pressure of the door seals followed and by the action of a user grasping the door.

FIG. 4 shows closing of the latch mechanism. When the door is slammed shut, the latch claw 1 rotates in the opposite direction, that of arrow F5′. The pawl 3 returns to its initial position, rotating about the axis 2 in the direction of arrow F1′, for example under the action of a spring (not illustrated) and can now again keep the latch claw 1 in the closed position.

When the latch claw 1 is rotating, it can operate switch contacts (not illustrated), supplying door electronics logic (also not shown) with “door open” status information. This information along with other information concerning the status of the switch contacts 17a and 17b of the electric motor 6 which actuates the electrical latch mechanism release will be used for powering the electric motor 6 with reverse polarity to bring the elements of the latch mechanism back to the rest position, as illustrated in FIG. 4.

From the above, it will be seen that the latch mechanism is brought to a release position by the combined action of a mechanical command and electrical command. The various lock functionalities such as locking of the latch mechanism, child-proof feature or override are done by the firmware of a non-illustrated microcontroller associated with the electrical release motor 6.

Thus, should the microcontroller fail and the electric motor 6 be powered at an inappropriate time, the electrical release lever 9 will just swing freely on the axis 2 without driving the cooperating means 5 since the key 11 will not have been engaged in the cooperating means 5 by operation of the mechanical release control. As the cooperating means 5 are not driven, the pawl 3 is not in a position to allow the latch claw 1 to move from its closed position. Any untoward opening of the door is thus avoided.

However, should the electric motor 6 fail to operate, it is nevertheless necessary to be able to open the door. If a problem which could affect operation of the electric motor 6 is detected, such as detection of impact, a drop in battery voltage, firmware failure or otherwise, a supervisory circuit (optionally redundant) with the microcontroller of the electric motors 6 will operate the standby motor 20, which will bring the backup lever 18 into a so-called active position. As illustrated on FIG. 5, in this position, the cam 18a of the backup lever 18 is coupled-in by the second finger 5e of the cooperating means 5. The cooperating means 5 is now no longer able to rotate about the axis 5a, but can only swing about the axis 2 constituting the point of coupling-in of the backup lever 18 on the cooperating means 5.

Operating the external release cable or rod mechanism 14 (or, respectively, the inside release control) will cause the external release lever 15 to make the recall lever 12 pivot as discussed above. As a result of the recall lever 12 pivoting about the axis 10, the pin 12b will be brought into abutment against the face 5f of the second window 5d of the cooperating means 5. As the cooperating means 5 are prevented from rotating about the axis 5a as a result of the second finger 5e thereof being coupled-in with the cam 18a of the backup lever 18, the cooperating means 5 are now driven in rotation about the axis 2 by the action of the pin 12b abutting inside the second window 5d. This rotation of the cooperating means 5 about the axis 2 will then drive the pawl lifter 4 via the lug housed inside the second window 5b of the cooperating means 5.

In effect, the shape of the second window 5b of the cooperating means 5 is designed to allow the lug of the pawl lifter 4 to initially slide inside the window when the cooperating means 5 swing about the axis of rotation 5a and to drive the lug, without initial sliding, when the cooperating means 5 swing about the coupling-in axis 2 along with the backup lever 18. For this purpose, the second window 5b adapted to house the lug of the pawl lifter 4 can be shaped in the form of an arc of a circle centered on the axis of rotation 5a of the cooperating means 5.

Thus, when the backup lever 18 is in its so-called active position, the lug of the pawl lifter 4 no longer slides inside the second window 5b of the cooperating means 5, but remains in abutment at the left-hand side thereof to drive integrally in rotation the pawl 3, and release the latch claw 1 from its closed position. The unidirectional linkage between the cooperating means 5 and the pawl 3 is thus coupled-in by the backup lever 18 in its active position. This allows the latch mechanism to be released mechanically even when the electrical operating control is faulty.

The backup lever 18 consequently has a so-called active position in which the cam 18a is coupled-in with the second finger Se of the cooperating means 5 for rotation of the cooperating means 5 about the axis 2 of the pawl lifter 4 and a so-called inactive position in which the cam 18a is coupled-out with respect to the second finger Se of the cooperating means 5 for rotation of the cooperating means 5 about the axis of rotation 5a. There is the possibility of an intermediate position in which direct coupling-in of the cam 18a is prevented as a result of prior rotation of the cooperating means 5.

Should incorrect operation of the electric motor 6 only be detected after the external release control has been operated, the cooperating means 5 will be in a position corresponding to that illustrated in FIG. 2. If the standby motor 20 is now set in motion, the cam 18a of the backup lever 18 cannot couple-in with the second finger 5e of the cooperating means 5, since the cooperating means 5 has already rotated about the axis 5a under the action of the mechanical release control. When there is no longer traction on the external release cable or rod mechanism 14, the release lever 15 and the recall lever 12 return to their initial position, as shown in FIG. 1. The cooperating means 5 now are recalled to their initial position, for example by a spring, not illustrated. The second finger 5e of the cooperating means 5 will now strike against the cam 18a of the backup lever 18 which has been operated. The backup lever 18 consequently carries a spring 19 adapted to allow the cam 18a be lifted by the second finger 5e of the cooperating means 5 in reverse rotation towards its rest position. Once the cooperating means 5 have returned to their initial position, the cam 18a of the backup lever 18 is now constrained by the spring 19 to abut against the second finger 5e. This engagement now constitutes the new axis 2 of rotation for the cooperating means 5.

The shape of the second window 5d of the cooperating means 5 in which the pin 12b of the recall lever 12 moves is important, as the shape should allow abutment of the pin 12b against the face 5f to allow the cooperating means 5 to move under the action of the recall lever 12, either about the axis 5a to engage the key 11 of the electrical release lever 9 or about the axis 2 of the pawl lifter 4.

Similarly, the shape of the second window 5d of the cooperating means 5 in which the pawl lifter lug is housed is also important as this allows unidirectional drive of the latch claw 1 via the cooperating means 5 when the linkage is coupled-in, regardless of about which axis of rotation, i.e., 2 or 5a, the cooperating means 5 pivot.

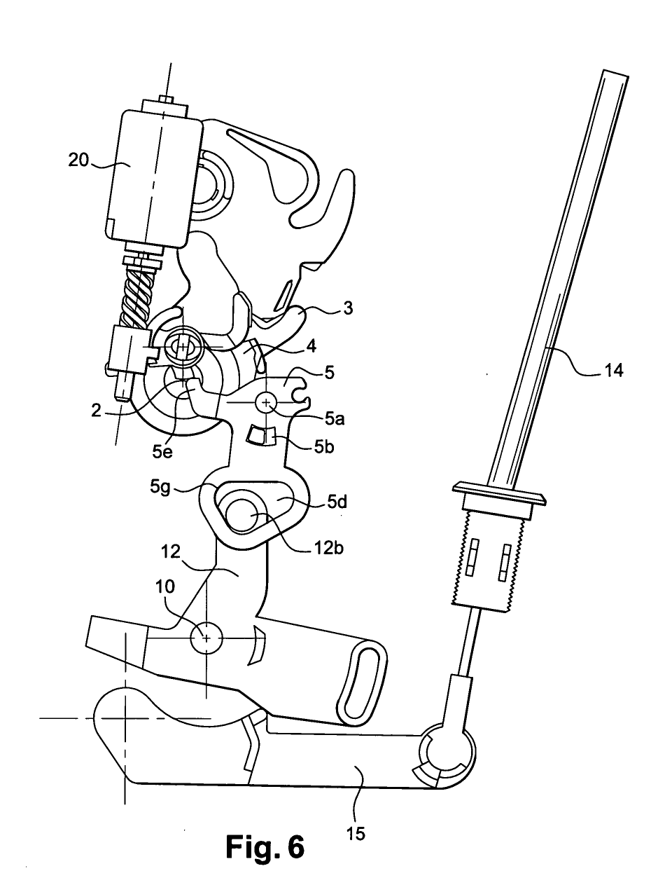

FIG. 6 illustrates another embodiment of the latch mechanism of the invention in a closed position. The latch mechanism of FIG. 6 has purely mechanical release. Those parts that are common to the latch mechanism discussed with reference to FIG. 1 bear the same reference numerals and will not be described again. The latch mechanism of FIG. 6 has no electrical release lever, but simply a manual release lever 15 linked to an external release control, as well as an inside release control lever (not shown).

The shape of the cooperating means 5 of the latch mechanism in FIG. 6 can differ from that of the latch mechanism previously described. In effect, the cooperating means 5 no longer has a finger adapted to engage with a key of an electrical release lever. Similarly, the shape of the second window 5d in which the pin 12b of the recall lever 12 moves is different from the one discussed above. The second window 5d constitutes a point of action of the cooperating means 5 by a lever. The cooperating means 5 in FIG. 6 does not have a point of action for a motor. The cooperating means 5 of FIG. 6 are simpler, but it will be understood that the shape described with reference to FIG. 1 could apply to this embodiment, with the point of action of a motor on the cooperating means 5 being simply inactive.

The latch mechanism of FIG. 6 operates as follows. The latch mechanism of FIG. 6 is a latch mechanism with mechanical release and electrical locking. To release the latch mechanism, the backup lever 18 is placed in an active position by the standby motor 20, in other words with the cam 18a coupled-in on the second finger 5e of the cooperating means 5.

If an action is performed on the external release cable or rod mechanism 14 or the inside release control, this will cause the external release lever 15 to make the recall lever 12 pivot as discussed above. Under the effect of this rotation of the recall lever 12 about the axis 10 in the counter clockwise direction, the pin 12b will be driven into abutment with the face 5g of the second window 5d of the cooperating means 5. As the cooperating means 5 are prevented from rotating about the axis 5a as a result of the second finger Se thereof being coupled to the cam 18a of the backup lever 18, the cooperating means 5 are now driven in rotation about the axis 2 by the point at which coupling-in has occurred. The swinging of the cooperating means 5 about the axis 2 then drives the pawl lifter 4 downwardly via the lug housed in the first window 5b of the cooperating means 5. As a result of the shape of the first window 5b of the cooperating means 5 discussed above, the lug of the pawl lifter 4 will not slide, but will remain in abutment at the left-hand side of the first window 5b of the cooperating means 5 to bring about rotation integral therewith of the pawl 3 and release of the latch claw 1 from its closed position. The unidirectional linkage between the cooperating means 5 and the pawl 3 is consequently coupled-in by the backup lever 18 in its active position.

Similarly, if the cooperating means 5 have the shape discussed with reference to FIG. 1, shifting of the pin 12b in the second window 5d in abutment against the face 5f brings about swinging of the cooperating means 5 about the axis 2 in the clockwise sense with integral driving of the pawl lifter 4 and the pawl 3.

In order to lock the latch mechanism, the backup lever 18 is placed in an inactive position by the standby motor 20, in other words with the cam 18a coupled-out with respect to the second finger Se of the cooperating means 5.

Operating the external (or respectively inside) release cable or rod mechanism 14 will cause the external release lever 15 to swing the recall lever 12 as described above. The pin 12b will be driven into abutment against the face 5g of the second window 5d of the cooperating means 5. As the cooperating means 5 are free to rotate about the axis 5a, shifting of the pin 12b in the second window 5d will cause the cooperating means 5 to rotate about the axis 5a in a clockwise direction. During this rotation of the cooperating means 5 about the axis 5a, as a result of the shape of the second window 5d described above, the lug of the pawl lifter 4 will simply slide in the second window 5b without causing rotation of the pawl 3 and release of the latch claw 1 from its closed position. The unidirectional linkage between the cooperating means 5 and the pawl 3 is consequently coupled-out by the backup lever 18 in its inactive position.

Similarly, if the cooperating means 5 have the shape described with reference to FIG. 1, movement of the pin 12b in the second window 5d will bring about clockwise rotation of the cooperating means 5 about the axis 5a. During such rotation of the cooperating means 5 about the axis 5a, the lug of the pawl lifter 4 will simply slide in the second window 5d of the cooperating means 5 without bringing about rotation of the pawl 3 and release of the latch claw 1 from its closed position, as illustrated in FIG. 3. The unidirectional linkage between the cooperating means 5 and the pawl 3 is consequently coupled-out by the backup lever 18 in its inactive position.

The latch mechanism according to the invention constitutes a modular assembly making it possible to implement all desired functionalities for a lock, starting from one basic core latch mechanism.

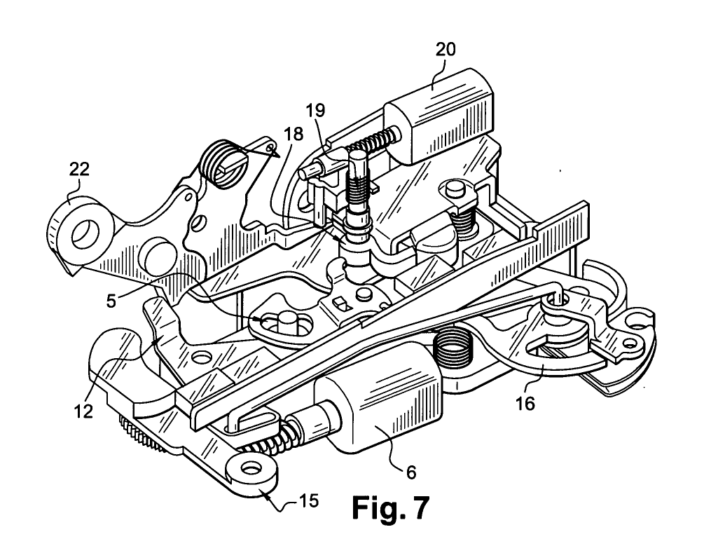

Depending on the programming of the standby motor 20 of the backup lever 18 and the possible addition of supplementary motors, rods, cooperating means and levers into the core of the latch mechanism according to the invention, it is possible to implement all functions of locking, security locking, simple and double override, child-proof feature and, obviously, to combine them all. FIGS. 7 to 11 do indeed show examples of embodiments of locks having various functionalities.

Thus, FIG. 7 shows one example of a latch mechanism module with electric release. The cooperating means 5 are able to be operated, in other words shifted, by acting on a mechanical release lever 12 linked to the external release lever 15 and the inside release control 22. The cooperating means 5 are also able to be operated by the electric motors 6 via a key of an electric release lever. This example of a latch mechanism module corresponds to the one discussed with reference to FIG. 5 with a standby motor 20 provided in case of failure of the electric motor 6. The latch mechanism in FIG. 7 additionally provides for electrical closing by operating on a closing lever 16 that acts on the latch claw 1. If the door is badly closed, for example as a result of the resistance of the door seals, a motor (not illustrated) can operate the closing lever 16 to bring the latch claw 1 to the closed position. The latch mechanism of FIG. 7 can, for example, be mounted on a front door of an automobile vehicle.

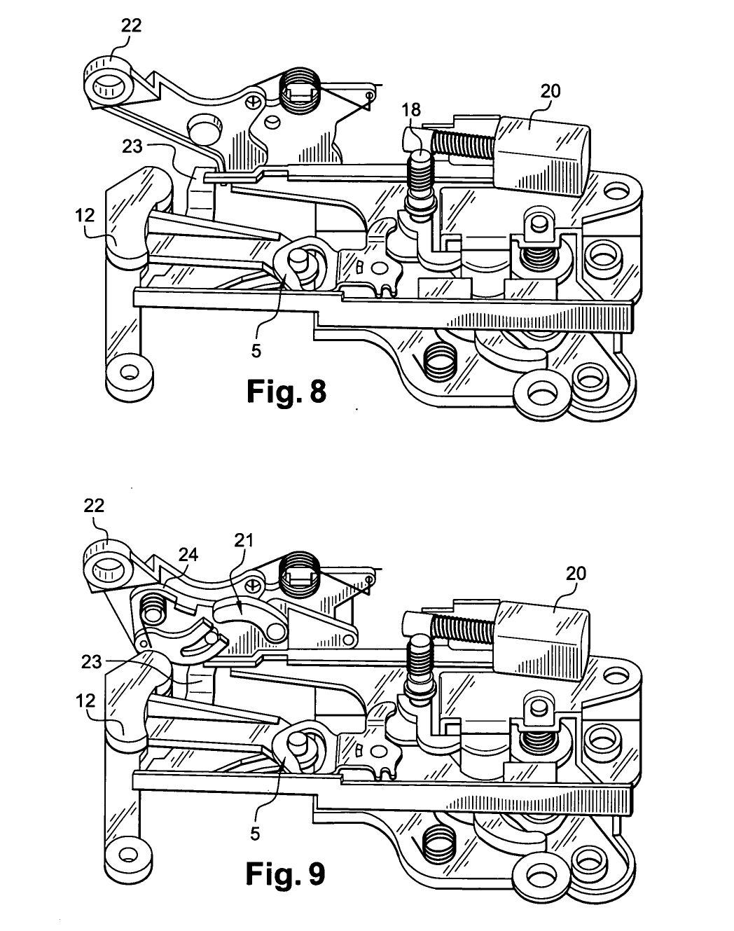

In the example of FIG. 8, the latch mechanism has purely mechanical release as described above with reference to FIG. 6. The point of action by the lever of the cooperating means 5 can be operated on by the recall lever 12. This figure shows the inside release lever 23 operated on by the inside release control 22 that acts on the recall lever 12 to thereby activate the point of action of the cooperating means 5. Suitable programming of the standby motor 20 can allow a central locking system to be implemented for coupling in or coupling out the unidirectional linkage between the cooperating means 5 and the pawl 3. The latch mechanism in FIG. 8 can, for example, be mounted on a front door of an automobile vehicle.

In the example of FIG. 9, the latch mechanism has purely mechanical release. The point of action by the lever of the cooperating means 5 can be activated by the recall lever 12. A hook member 21 and an intermediate inside release lever 24 are added to the inside release control 22 to constitute a mechanical child-proof feature with simple override. The arrangement illustrated on FIG. 9 consequently allows, starting out from the core of the latch mechanism identical to that in FIG. 8 and with the addition of a few parts, to provide a lock with a child-proof feature and simple override. Suitable programming of the standby motor 20 can also allow a centralized locking system to be implemented as described with reference to FIG. 8. The latch mechanism in FIG. 9 can, for example, be mounted on the front door of an automobile vehicle.

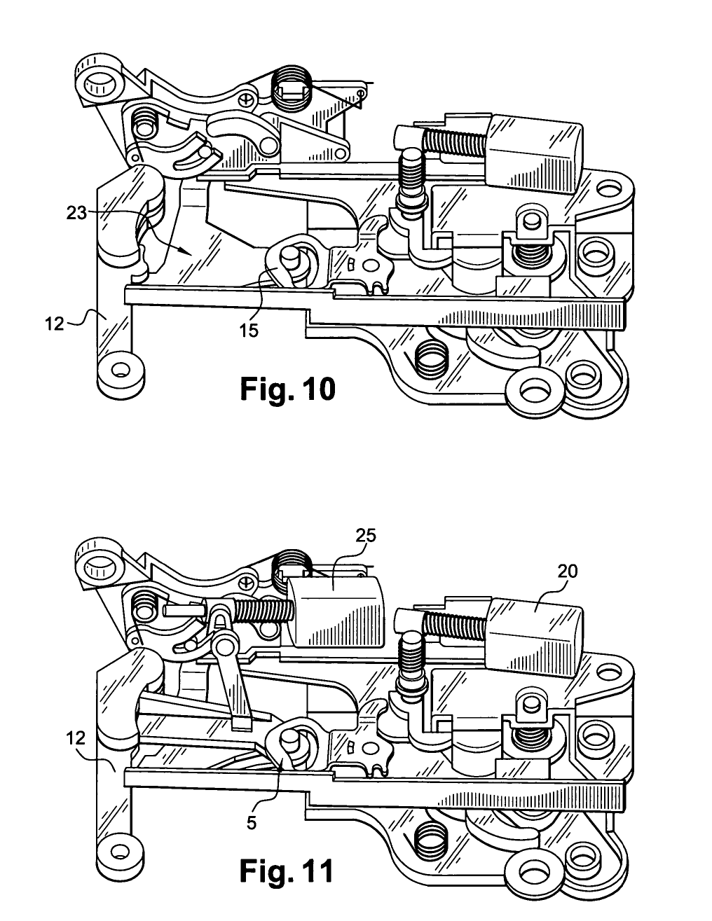

The example in FIG. 10 simply differs from that in FIG. 9 by a relative arrangement that is different of the recall lever 12 and the inside release lever 23 to constitute a mechanical child-proof feature with double override. The latch mechanism of FIG. 10 can, for example, be mounted on a rear door of an automobile vehicle. In the example of FIG. 11, the latch mechanism has purely mechanical release. The point of action by lever of the cooperating means 5 can be activated by recall lever 12. The movement of the recall lever 12 can be blocked or actuated by a rod connected by a lug to a ring driven by a worm gear of a supplemental motor 25. The supplementary motor 25 allows the inside release lever to be coupled-in or coupled-out electrically. Depending on the programming of the supplementary motor 25, an electrical child-proof feature or a security locking feature can be implemented. Suitable programming of the standby motor 20 can also allow a centralized locking function to be implemented as described with reference to FIG. 8. The latch mechanism of FIG. 11 can, for example, be mounted on the rear door of an automobile vehicle.

It will thus be noticed, from the examples of FIGS. 7-11, that the same latch mechanism core according to the invention makes it possible to provide, depending on the parts added to the assembly and the programming of the associated motor or motors, all functionalities expected of an automobile vehicle lock.

Obviously, this invention is not limited to the embodiments described by way of example with reference to the drawings. In particular, the shapes and dimensions of the various operating levers and motors associated with the latch mechanism of the invention can vary greatly. The latch mechanism according to the invention constitutes a core to which there can be added, in modular fashion, other elements. In particular, by simply modifying the programming of the standby motor 20 that operates the backup lever 18, numerous different functionalities can be obtained for the same latch mechanism.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An electromechanical latch mechanism comprising:
a latch claw movable between a released position in which the electromechanical latch mechanism is released and a closed position in which the electromechanical latch mechanism is closed;
a pawl to maintain the latch claw in the closed position;
a cooperating feature having a point of action to be operated on by a latch mechanism release lever; and
a unidirectional linkage that can be coupled-in and coupled-out electrically between the cooperating feature and the pawl.

2. The latch mechanism according to claim 1, wherein the cooperating feature includes another point of action to be operated on by an electric motor.

3. The latch mechanism of claim 1, further including a standby lever operated by a standby motor and moveable between an active position for coupling-in the cooperating feature and an inactive position for coupling-out the cooperating feature.

4. The latch mechanism according to claim 3, wherein the cooperating feature includes a finger, and the standby lever includes a cam that abuts the finger when the standby lever is in the active position.

5. The latch mechanism according to claim 3, wherein the standby lever carries a spring that permits the standby lever to have an intermediate position between the active position and the inactive position.

6. The latch mechanism according to claim 1, wherein the cooperating feature includes a window that receives a lug integral with the pawl, and the window is shaped to provide the unidirectional linkage between the cooperating feature and the pawl when the unidirectional linkage is in a coupled-in state.

7. The latch mechanism according to claim 6, wherein the cooperating feature includes a finger having another point of action to be acted on by an electric motor.

8. The latch mechanism according to claim 1, wherein the cooperating feature includes a window that defines the point of action to be operated on by the latch mechanism release lever.

9. A module comprising:
an electromechanical latch mechanism including:
a latch claw movable between a release position in which the electromechanical latch mechanism is released and a closed position in which the electromechanical latch mechanism is closed,
a pawl to maintain the latch claw in the closed position,
a cooperating feature having a point of action to be operated on by a latch mechanism release lever, and
a unidirectional linkage that can be coupled-in and coupled-out electrically between the cooperating feature and the pawl;
an electrical release motor for the electromechanical latch mechanism to act on the cooperating feature, wherein the unidirectional linkage between the cooperating feature and the pawl is coupled-in by the electric release motor; and
a mechanical release lever to act on the cooperating feature.

10. The module of claim 9, further including a standby lever to be operated by a standby motor, wherein the unidirectional linkage between the cooperating feature and the pawl is coupled-in by the standby lever if the electrical release motor electronically fails.

11. A module comprising:
an electromechanical latch mechanism including:
a latch claw movable between a release position in which the electromechanical latch mechanism is released and a closed position in which the electromechanical latch mechanism is closed,
a pawl to maintain the latch claw in the closed position,
a cooperating feature having a point of action to be operated on by a latch mechanism release lever, and
a unidirectional linkage that can be coupled-in and coupled-out electrically between the cooperating feature and the pawl;
a mechanical release lever to act on the cooperating feature; and
a standby lever to be operated on by a standby motor, wherein the unidirectional linkage between the cooperating feature and the pawl is coupled-in and coupled-out by the standby lever.
